(19) United States
(12) Patent Application Publication
(10) Pub. No.: US 2023/0339044 A1
(43) Pub. Date: Oct. 26, 2023

(54) PROCESSING APPARATUS AND ARTICLE MANUFACTURING METHOD

(71) Applicant: CANON KABUSHIKI KAISHA, Tokyo (JP)

(72) Inventors: Ryo IKUTA, Tochigi (JP); Hiroyuki MORIMOTO, Tochigi (JP)

(21) Appl. No.: 18/301,445

(22) Filed: Apr. 17, 2023

(30) Foreign Application Priority Data
Apr. 26, 2022 (JP) 2022-072673

(51) Int. Cl. B23K 26/082; B23K 26/06; B23K 26/70

(52) U.S. Cl. CPC B23K 26/082; B23K 26/0648; B23K 26/0665; B23K 26/705

(57) ABSTRACT

A processing apparatus that processes a workpiece by irradiating the workpiece with laser light, the apparatus including a rotation unit configured to rotate with a rotation axis as a center, thereby rotating an intensity distribution of the laser light emitted therefrom with the rotation axis as a center, a scanning unit configured to scan the laser light applied to the workpiece, and a control unit configured to irradiate the workpiece with the laser light while reducing at least one of an angular shift and a positional shift of the laser light entering the workpiece, which occur due to a shift between the rotation axis and a barycentric line of the laser light entering the rotation unit.

### BACKGROUND OF THE INVENTION

### Field of the Invention

The present invention relates to a processing apparatus and an article manufacturing method.

### Description of the Related Art

A laser processing apparatus is an apparatus that performs various kinds of processes (for example, hole machining) on a workpiece by scanning and condensing laser light on the workpiece using a movable mirror such as a galvano scanner and a condenser lens. In recent years, Germany Patent No. 102004053298 has proposed a laser processing apparatus that can control, with high accuracy, the hole diameter of a machined hole and the angle of a wall surface by controlling the incident angle of laser light condensed on a workpiece.

However, in the conventional laser processing apparatus, if the shape of the laser light condensed on the workpiece is distorted, this influences the machined hole formed in the workpiece, and it is difficult to form the machined hole having a desired shape.

### SUMMARY OF THE INVENTION

The present invention provides a processing apparatus advantageous in processing a workpiece with high accuracy.

According to one aspect of the present invention, there is provided a processing apparatus that processes a workpiece by irradiating the workpiece with laser light, the apparatus including a rotation unit configured to rotate with a rotation axis as a center, thereby rotating an intensity distribution of the laser light emitted therefrom with the rotation axis as a center, a scanning unit configured to scan the laser light applied to the workpiece, and a control unit configured to irradiate the workpiece with the laser light while reducing at least one of an angular shift and a positional shift of the laser light entering the workpiece, which occur due to a shift between the rotation axis and a barycentric line of the laser light entering the rotation unit.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a processing apparatus as one aspect of the present invention.

FIG. 2 is a view for explaining the arrangement and action of an image rotator of the processing apparatus shown in FIG. 1.

FIG. 3 is a view for explaining the trajectory of laser light condensed on a workpiece.

FIG. 4 is a view for explaining the trajectory of laser light condensed on the workpiece.

FIGS. 5A and 5B are views for explaining the arrangement and action of a sensor unit of the processing apparatus shown in FIG. 1.

FIG. 6 is a view showing a state in which a positional error and an angular error occur between the rotation axis of the image rotator and the optical axis of the laser light.

FIG. 7 is a flowchart illustrating a process procedure of the processing apparatus shown in FIG. 1.

FIG. 8 is a view for explaining the trajectory of laser light condensed on a workpiece.

FIG. 9 is a flowchart illustrating another process procedure of the processing apparatus shown in FIG. 1.

FIGS. 10A and 10B are views for explaining a process concerning adjustment of the image rotator of the processing apparatus shown in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

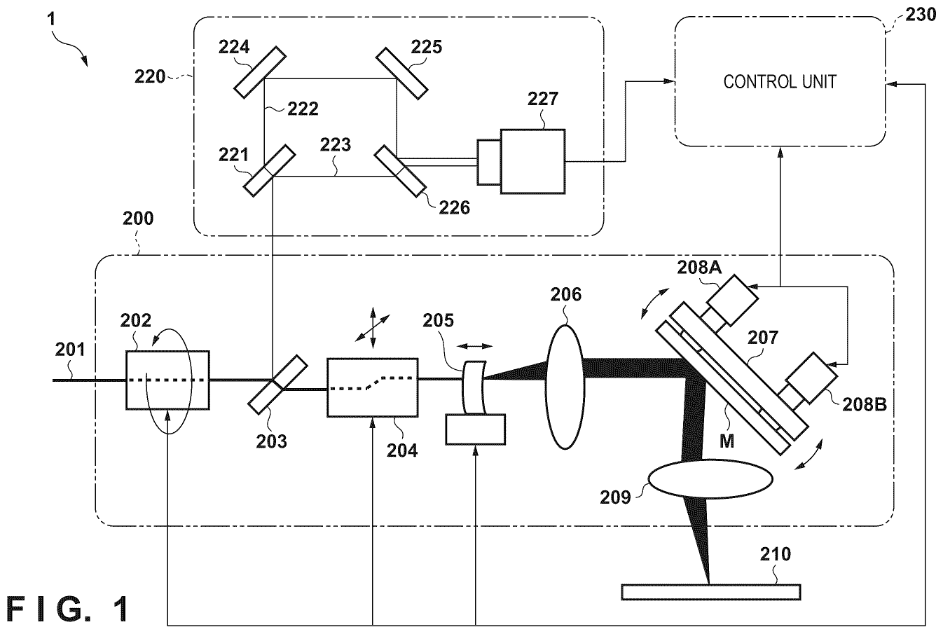

FIG. 1 is a schematic view showing the arrangement of a processing apparatus 1 as one aspect of the present invention. The processing apparatus 1 is a laser processing apparatus that processes a workpiece 210 by irradiating the workpiece 210 with laser light 201 (laser beam). The processing apparatus 1 can perform various kinds of processes on the workpiece 210, but in this embodiment, the processing apparatus 1 is embodied as an apparatus that performs hole machining on the workpiece 210. As shown in FIG. 1, the processing apparatus 1 includes a processing head unit 200, a sensor unit 220, and a control unit 230.

The processing head unit 200 includes an image rotator 202, a first partial transmission mirror 203, a shifter unit 204, a first enlarging lens 205, a second enlarging lens 206, a scanner unit 207, and a condenser lens 209.

The image rotator 202 rotates coaxially with the laser light 201, and has a function of allowing the laser light 201 emitted therefrom to rotate on its axis. The image rotator 202 functions as a rotation unit that rotates around a rotation axis, thereby allowing the intensity distribution of the laser light 201 emitted therefrom to rotate around the rotation axis.

The first partial transmission mirror 203 branches (separates) the laser light 201 emitted from the image rotator 202 into laser light which enters the sensor unit 220, and laser light which enters the shifter unit 204. Accordingly, a part of the laser light 201 emitted from the image rotator 202 enters the sensor unit 220 via the first partial transmission mirror 203, and the remaining part enters the shifter unit 204.

The shifter unit 204 is provided on the subsequent stage of the image rotator 202. A movable mirror or a movable transparent substrate having a plurality of rotational degrees of freedom is included inside the shifter unit 204. The shifter unit 204 translates (shifts) the incident laser light 201 in the vertical and horizontal directions. In this embodiment, the shifter unit 204 functions as a first scanning unit that changes the position of the laser light 201 applied to (entering) the workpiece 210. By cooperating with the scanner unit 207 which functions as a second scanning unit that changes the angle of the laser light 201 applied to (entering) the workpiece 210, the shifter unit 204 also functions as a scanning unit that scans the laser light 201 applied to the workpiece 210.

Each of the first enlarging lens 205 and the second enlarging lens 206 enlarges the beam diameter of the laser light emitted from the shifter unit 204. The first enlarging lens 205 is provided so as to be movable along the traveling direction of the laser light 201.

The laser light 201 with the beam diameter enlarged by the first enlarging lens 205 and the second enlarging lens 206 is reflected by the scanner unit 207, and condensed on the workpiece 210 via the condenser lens 209. The scanner unit 207 is provided on the subsequent stage of the image rotator 202, and includes, for example, a reflection mirror M that reflects the laser light 201, and a first actuator 208A and a second actuator 208B configured to drive the reflection mirror M. The scanner unit 207 can adjust the reflection angle of the laser light 201 in two directions by driving the reflection mirror M by the first actuator 208A and the second actuator 208B.

The laser light 201 reflected (branched) by the first partial transmission mirror 203 enters the sensor unit 220. The sensor unit 220 includes a second partial transmission mirror 221, a first reflection mirror 224, a second reflection mirror 225, a third partial transmission mirror 226, and a sensor 227.

The second partial transmission mirror 221 branches (separates) the laser light 201 having entered the sensor unit 220 into laser light which passes through a first optical path 222, and laser light which passes through a second optical path 223. The laser light 201 passing through the first optical path 222 is reflected by the third partial transmission mirror 226 via the first reflection mirror 224 and the second reflection mirror 225, and enters the sensor 227. The laser light 201 passing through the second optical path 223 is transmitted through the third partial transmission mirror 226, and enters the sensor 227. The sensor 227 detects the respective positions of the two incident laser light beams 201, and transmits the positions to the control unit 230 as position information.

The control unit 230 is formed by a computer (information processing apparatus) including a CPU, a memory, and the like and, for example, operates the processing apparatus 1 by comprehensively controlling respective units of the processing apparatus 1 in accordance with a program stored in a storage unit. In this embodiment, the control unit 230 controls the image rotator 202, the shifter unit 204, the first enlarging lens 205 (actuator included therein), and the first actuator 208A and the second actuator 208B included in the scanner unit 207. Further, the control unit 230 has various kinds of calculation (arithmetic) functions and, based on the position information transmitted from the sensor 227, obtains the fluctuation of the laser light 201 and generates a driving signal for driving each actuator. In this embodiment, the control unit 230 performs a process of irradiating the workpiece 210 with the laser light 201 to process the workpiece 210.

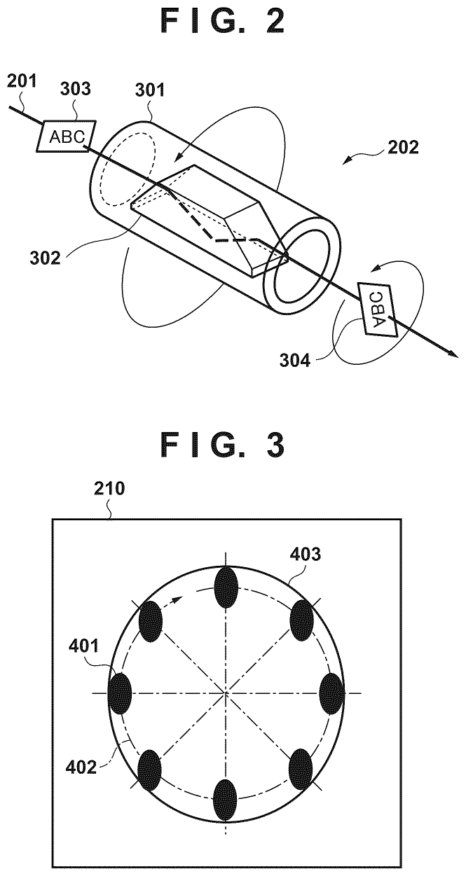

With reference to FIG. 2, the arrangement and action of the image rotator 202 will be described. The image rotator 202 includes an image rotation element 302 configured to rotate the image (light flux) of the laser light 201, and a housing 301 that accommodates the image rotation element 302. For example, the image rotator 202 is formed by inserting the image rotation element 302 to the inside of the housing 301.

In this embodiment, the image rotation element 302 is formed by a prism having a trapezoid cuboid shape, and referred to as, for example, a dope prism or a dove prism. The image rotation element 302 has characteristics of inverting/rotating the laser light 201 inside it. For example, along with a rotation of the image rotation element 302, an incident image 303 (intensity distribution) of the laser light 201 is changed to an emission image 304 (intensity distribution). More specifically, it is known that when the image rotation element 302 (dope prism) rotates once, the emission image 304 rotates at twice the cycle (that is, rotates twice).

In this embodiment, the housing 301 is configured to be rotatable coaxially with the laser light 201 and integrally with the image rotation element 302. Accordingly, when the housing 301 rotates, the image rotation element 302 also rotates, and the laser light 201 emitted therefrom rotates (on its axis). The housing 301 (image rotator 202) is rotated using, for example, an electromagnetic or pneumatic actuator. A sensor provided in the actuator detects the rotation speed and the number of rotations, and they are transmitted to the control unit 230 as operation information.

With reference FIG. 3, the trajectory of the laser light 201 condensed on the workpiece 210 will be described. FIG. 3 shows a state in which the laser light 201 is condensed on the workpiece 210 with the image rotator 202 fixed (that is, without rotating the image rotator 202) in the processing head unit 200. As has been described above, the laser light 201 is condensed on the workpiece 210 via the condenser lens 209. In FIG. 3, an example of the shape of the laser light 201 condensed on the workpiece 210 is shown as a condensed shape 401 of the laser light 201. The reason why the condensed shape 401 becomes an elliptical shape is considered to be a distortion of the intensity distribution caused by the characteristics of an oscillator of the laser light 201, and the influence of aberrations of an optical system provided on the preceding stage of the processing head unit 200 and aberrations of the optical system of the processing head unit 200. Note that the shape (condensed shape) of the laser light 201 condensed on the workpiece 210 is not necessarily the elliptical shape, and a center asymmetric distorted shape or the like is also assumed.

In the processing head unit 200, by operating the shifter unit 204 and the scanner unit 207 interlockingly, the laser light 201 (condensed point thereof) is scanned along a trajectory 402 (that is, so as to draw the circular trajectory 402). With this, a machined hole 403 is formed in the workpiece 210. However, if the condensed shape 401 of the laser light 201 is distorted, this influences the shape of the machined hole 403 formed in the workpiece 210. In FIG. 3, the shape of the machined hole 403 is elliptic with respect to the perfectly circular trajectory 402, so that an error has occurred in the processed shape. Such a problem also occurs in the conventional processing apparatus disclosed in patent literature 1.

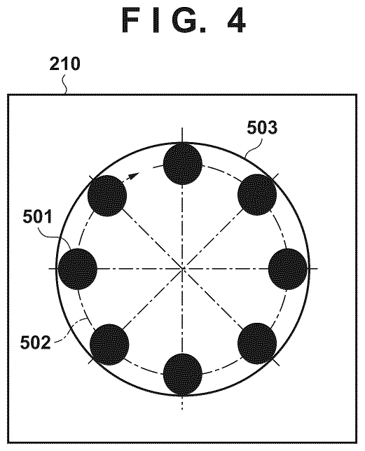

FIG. 4 shows a state in which the laser light 201 is condensed on the workpiece 210 with the image rotator 202 rotated in the processing head unit 200. As has been described above, the laser light 201 is condensed on the workpiece 210 via the condenser lens 209. At this time, the laser light 201 rotates (on its own axis) along with the rotation of the image rotator 202, so that a condensed shape 501 formed by the distorted shape averaged to the perfectly circular intensity is obtained as the shape of the laser light 201 condensed on the workpiece 210. Therefore, while processing the workpiece 210 by irradiating the workpiece 210 with the laser light 201, the image rotator 202 is rotated such that the image rotator 202 is constantly rotated. With this, as the shape of the laser light 201 entering at each position of a trajectory 502 (on the trajectory), the perfectly circular condensed shape 501 can be obtained.

In the processing head unit 200, by operating the shifter unit 204 and the scanner unit 207 interlockingly, the laser light 201 (condensed point thereof) is scanned along the trajectory 502. With this, a machined hole 503 is formed in the workpiece 210. Since the condensed shape 501 of the laser light 201 is averaged to the perfectly circular shape, the shape of the machined hole 503 formed in the workpiece 210 becomes similar to the shape of the trajectory 502. Therefore, even if the condensed shape of the laser light 201 is distorted, the shape of the machined hole 503 is not influenced by this, and no error occurs in the processed shape.

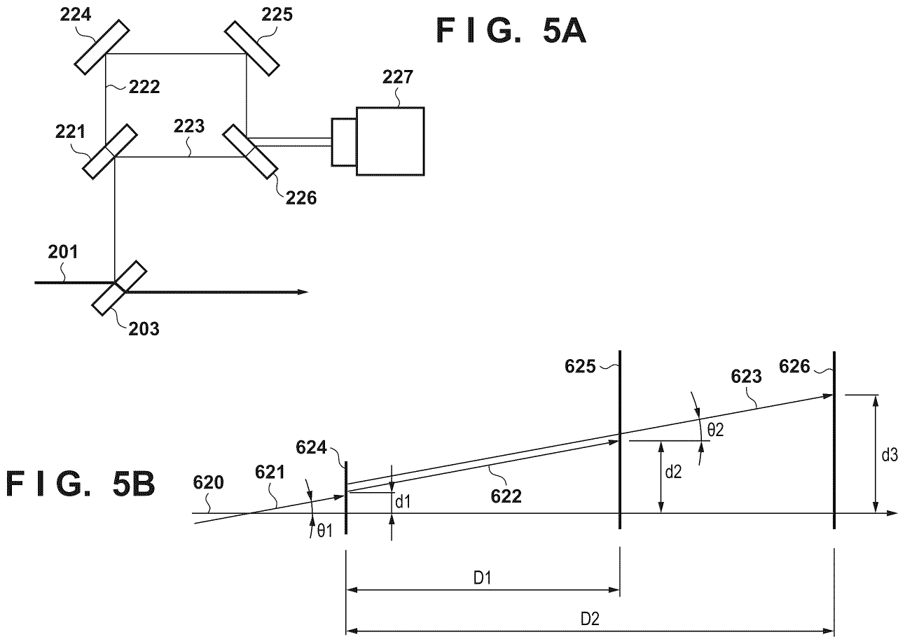

With reference to FIGS. 5A and 5B, the arrangement and action of the sensor unit 220 will be described. FIG. 5A is a view partially showing the sensor unit 220 shown in FIG. 1, and FIG. 5B is a view for explaining the measurement principle of the sensor unit 220.

Referring to FIG. 5A, the laser light 201 reflected (branched) by the first partial transmission mirror 203 is branched (separated), via the second partial transmission mirror 221, into the laser light which passes through the first optical path 222 and the laser light which passes through the second optical path 223. The laser light passing through the first optical path 222 is reflected by the third partial transmission mirror 226 via the first reflection mirror 224 and the second reflection mirror 225, and enters the sensor 227. The laser light 201 passing through the second optical path 223 is transmitted through the third partial transmission mirror 226, and enters the sensor 227.

Referring to FIG. 5B, an optical axis 620 expresses the optical axis in the initial state of the laser light 201 which is reflected by the first partial transmission mirror 203 and enters the sensor unit 220. An optical axis 621 expresses the optical axis in the state in which the position and angle of the optical axis 620 have fluctuated due to some factor. A second partial transmission mirror surface 624 is a surface schematically showing the reflection surface of the second partial transmission mirror 221 shown in FIG. 5A along the optical axis. An angular shift θ1 and a positional shift dl are fluctuation components of the optical axis on the second partial transmission mirror surface 624. A first sensor surface 625 is a surface schematically showing the light receiving surface of the sensor 227 via the second optical path 223 in FIG. 5A. A second sensor surface 626 is a surface schematically showing the light receiving surface of the sensor 227 via the first optical path 222 in FIG. 5A. D1 denotes the distance on design from the second partial transmission mirror surface 624 to the first sensor surface 625, and corresponds to the optical path length on design of the second optical path 223 shown in FIG. 5A. D2 denotes the distance on design from the second partial transmission mirror surface 624 to the second sensor surface 626, and corresponds to the optical path length on design of the first optical path 222 shown in FIG. 5A.

An optical path 622 schematically expresses the optical path of the laser light 201 in the second optical path 223 after the fluctuation. An optical path 623 schematically expresses the optical path of the laser light 201 in the first optical path 222 after the fluctuation. In FIG. 5A, the light receiving surface of the sensor 227 for the first optical path 222 and that for the second optical path 223 are the same. However, in FIG. 5B, they are schematically set as two sensor surfaces (the first sensor surface 625 and the second sensor surface 626) respectively corresponding to the distance D1 and the distance D2 from the second partial transmission mirror surface 624. Accordingly, the difference in optical path length between the first optical path 222 and the second optical path 223 in FIG. 5A is equivalent to the difference between the distance D2 and the distance D1 in FIG. 5B.

d2 denotes the incident point movement amount on the first sensor surface 625 after the optical axis fluctuation. This schematically shows the change of the incident position, to the sensor 227, of the laser light passing through the first optical path 222 in FIG. 5A. d3 denotes the incident point movement amount on the second sensor surface 626 after the optical axis fluctuation. This schematically shows the change of the incident position, to the sensor 227, of the laser light passing through the second optical path 223 in FIG. 5A. θ2 denotes the angular shift (angle fluctuation component) of the optical axis on the first sensor surface 625. In principle, the angular shift θ2 coincides with the angular shift θ1.

A series of steps concerning calculation (calculation method) of the amount of optical axis fluctuation in the control unit 230 will be described below. First, in the first step, the angle component of the optical axis fluctuation is calculated from the measurement results (respective positions of the two laser light beams having entered the sensor 227) of the sensor unit 220. In FIG. 5B, the angular shift θ2 is expressed by arctan((d3−d2)/(D2−D1)). As has been described above, the angular shift θ2 coincides with the angular shift θ1 in principle. Accordingly, the angular shift θ1 as the angle component of the optical axis fluctuation can be calculated by arctan((d3−d2)/(D2−D1)).

Then, in the second step, the position component of the optical axis fluctuation is calculated from the measurement results of the sensor unit 220. In FIG. 5B, the positional shift dl is expressed by d2−D1×tan(θ2). Accordingly, the positional shift d1 as the position component of the optical axis fluctuation can be calculated from the above formula.

With the series of steps (the first step and the second step) described above, the angle component (angular shift θ1) and position component (positional shift d1) of the optical axis fluctuation can be calculated from the measurement results of the sensor unit 220.

Note that the relative effective ratio between the angle component and the position component may be changed by providing, in the optical path of the sensor unit 220, an optical system whose optical magnification ratio is changed by a combination of lenses or the like. For example, if the optical system of 2× optical magnification is provided in the optical path of the sensor unit 220, the angle component and position component of the emitted laser light change ½ times and twice, respectively, with respect to the fluctuation of the incident laser light.

In this embodiment, as has been described above, the image rotator 202 is rotated coaxially with the laser light 201 entering the image rotator 202 by the electromagnetic or pneumatic actuator. However, if the optical axis of the laser light 201 entering the image rotator 202 fluctuates with time, a positional error (shift) and an angular error (shift) occur between the rotation center (rotation axis) of the image rotator 202 and the optical axis (barycentric line (the line through which the barycenter (center) of the laser light 201 passes)) of the laser light 201.

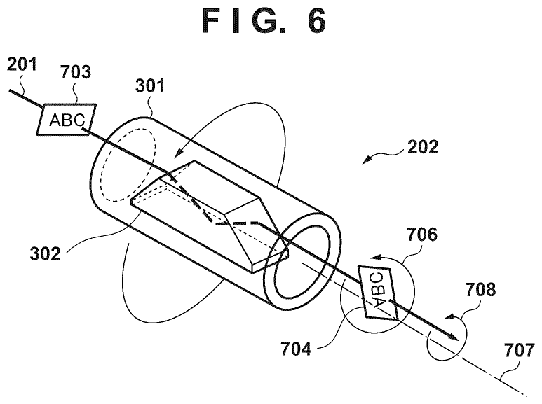

FIG. 6 is a view showing a state in which a positional error and an angular error occur between a rotation axis 707 of the image rotator 202 and the optical axis of the laser light 201. If the optical axis of the laser light 201 fluctuates with respect to the rotation axis 707 of the image rotator 202, in addition to a rotation component 706, a revolution component 708 in synchronization with the rotation cycle of the image rotator 202 is generated in an emitted image 704 of the laser light 201 emitted from the image rotator 202. As a result, a revolution component is also generated in the laser light 201 condensed on the workpiece 210 shown in FIG. 4, and an error (processing error) occurs in the shape of the machined hole formed in the workpiece 210. Since the optical axis fluctuation of the laser light 201 can occur due to displacements caused by temperature changes of the oscillator of the laser light 201, the optical system provided on the preceding stage of the processing head unit 200, and the optical system of the processing head unit 200, the direction and fluctuation amount of the optical axis fluctuation of the laser light 201 change with time. Hence, it is required to continuously detect and correct the direction and fluctuation amount of the optical axis fluctuation changing with time.

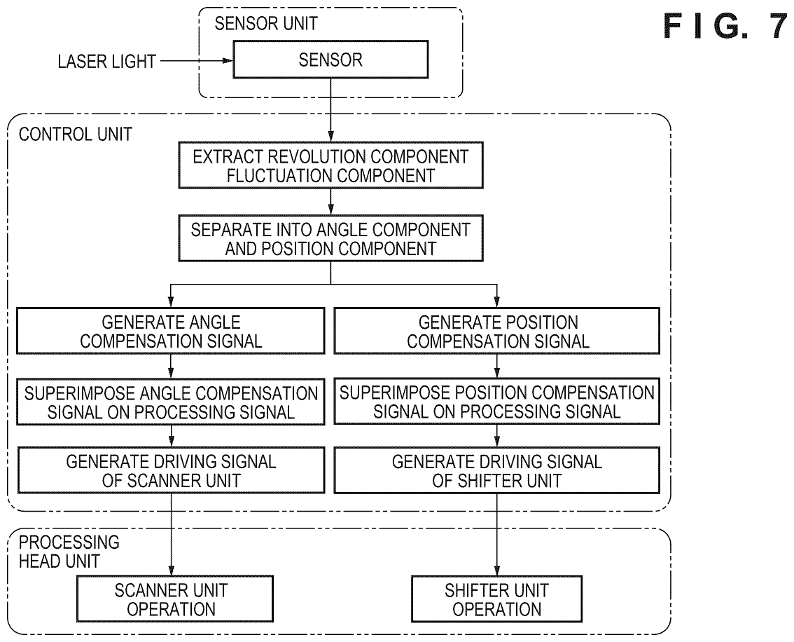

FIG. 7 is a flowchart illustrating a process procedure of the processing head unit 200, the sensor unit 220, and the control unit 230 performed to compensate the processing error caused by the revolution component generated in the image (emitted image) of the laser light 201 emitted from the image rotator 202.

Referring to FIG. 7, first, the sensor unit 220 (sensor 227) detects the position of the laser light 201 (the laser light passing through the first optical path 222 and the laser light passing through the second optical path 223) emitted from the image rotator 202, and transmits the detection signal (position information) to the control unit 230.

Then, from the detection signal transmitted from the sensor unit 220, the control unit 230 extracts the positional error and the angular error between the optical axis of the laser light 201 and the rotation axis of the image rotator 202, that is, the revolution component serving as the fluctuation component generated due to the optical axis fluctuation of the laser light 201. For example, the control unit 230 analyzes the detection signal from the sensor unit 220 with the frequency component, thereby extracting the revolution component which is in synchronization with the number of rotations of the image rotator 202. Further, the control unit 230 separates the revolution component (fluctuation component) extracted from the detection signal into the angle component and the position component by the calculation described with reference to FIG. 5B.

Then, the control unit 230 generates an angle compensation signal (period and amplitude thereof) for canceling (reducing) the separated angle component, and a position compensation signal (period and amplitude thereof) for canceling (reducing) the separated position component. The control unit 230 superimposes the angle compensation signal on a processing signal for controlling the angle of the laser light 201 applied to the workpiece 210 upon processing the workpiece 210, thereby generating a driving signal for driving the scanner unit 207. Similarly, the control unit 230 superimposes the position compensation signal on a processing signal for controlling the position of the laser light 201 applied to the workpiece 210 upon processing the workpiece 210, thereby generating a driving signal for driving the shifter unit 204. Note that the processing signal for controlling the angle or position of the laser light 201 is a set signal prepared in advance without considering the revolution component (fluctuation component) generated due to the optical axis fluctuation of the laser light 201.

The driving signal generated by superimposing the angle compensation signal on the processing signal for controlling the angle of the laser light 201 applied to the workpiece 210 is given from the control unit 230 to the scanner unit 207. On the other hand, the driving signal generated by superimposing the position compensation signal on the processing signal for controlling the position of the laser light 201 applied to the workpiece 210 is given from the control unit 230 to the shifter unit 204. With this, in the processing head unit 200, the shifter unit 204 and the scanner unit 207 operate interlockingly. At this time, since the driving signals generated by respectively superimposing the compensation signals on the processing signals are used, the revolution component (fluctuation component) generated due to the optical axis fluctuation of the laser light 201 is canceled. Thus, it is possible to form the machined hole in the workpiece 210 with no processing error.

In this manner, in this embodiment, the sensor unit 220 detects the fluctuation in at least one of the angle and position of the laser light 201 entering the workpiece 210, which occurs due to a shift between the optical axis of the laser light 201 and the rotation axis of the image rotator 202 in synchronization with a rotation of the image rotator 202. Then, in the control unit 230, while reducing (compensating) the fluctuation detected by the sensor unit 220 using the shifter unit 204 and the scanner unit 207, a process of irradiating the workpiece 210 with the laser light 201 is performed. Therefore, according to the processing apparatus 1 of this embodiment, even if the optical axis of the laser light 201 fluctuates, it is possible to perform processing with reduced influence of the fluctuation. Thus, it is possible to process the workpiece 210 with high accuracy.

Note that in this embodiment, of the revolution component (fluctuation component) generated due to the optical axis fluctuation of the laser light 201, the position component is reduced by the shifter unit 204, and the angle component is reduced by the scanner unit 207. However, the present invention is not limited to this. For example, a unit having both the function of the shifter unit 204 and the function of the scanner unit 207 may be formed, and this unit may reduce both the position component and the angle component.

In this embodiment, the laser light 201 branched immediately after the image rotator 202 enters the sensor unit 220, but the branch position of the laser light 201 which enters the sensor unit 220 is not limited to the position immediately after the image rotator 202. For example, a part of the reflection mirror M of the scanner unit 207 may be formed as a partial transmission mirror, and the laser light 201 branched by the scanner unit 207 may enter the sensor unit 220.

Further, in this embodiment, the scanner unit 207 can adjust the reflection angle of the laser light 201 in two directions by driving the reflection mirror M by the first actuator 208A and the second actuator 208B. However, the present invention is not limited to this configuration. For example, the laser light 201 may be scanned using two sets of movable mirrors such as galvano scanners.

### Second Embodiment

In the second embodiment, in a processing apparatus 1 shown in FIG. 1, a shifter unit 204 and a scanner unit 207 are operated interlockingly at a predetermined cycle with respect to the number of rotations of an image rotator 202.

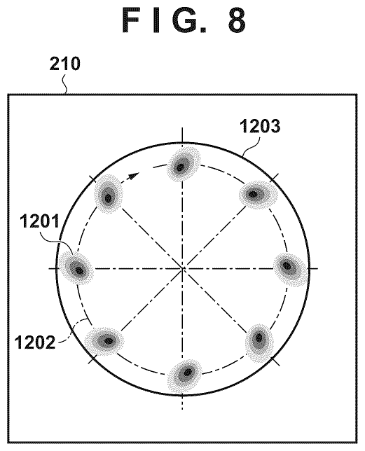

FIG. 8 shows a state in which laser light 201 is condensed on a workpiece 210 with the image rotator 202 rotated in a processing head unit 200. As has been described above, the laser light 201 is condensed on the workpiece 210 via a condenser lens 209.

In the processing head unit 200, by operating the shifter unit 204 and the scanner unit 207 interlockingly, the laser light 201 (condensed point thereof) is scanned along a trajectory 1202. With this, a machined hole 1203 is formed in the workpiece 210. However, if a condensed shape 1201 of the laser light 201 is distorted, this influences the shape of the machined hole 1203 formed in the workpiece 210.

To prevent this, in this embodiment, the image rotator 202 is rotated at ½ the cycle of the trajectory 1202 so as to allow the laser light 201 to rotate (on its own axis) in the same direction as the direction (revolution direction) along the trajectory 1202. In other words, the image rotator 202 is rotated half while the laser light 201 is scanned (revolves) once along the trajectory 1202. With this, the condensed shapes 1201 having the same intensity distribution (same intensity) in the radial direction of the circle defined by the trajectory 1202 are obtained. Accordingly, the shape of the machined hole 1203 formed in the workpiece 210 becomes similar to the shape of the trajectory 1202. Therefore, even if the condensed shape of the laser light 201 is distorted, the shape of the machined hole 1203 is not influenced by this, and no error occurs in the processed shape. Here, the shape of the machined hole formed in the workpiece 210 is a circle (circular shape). However, the present invention is not limited to this, and various shapes such as an ellipse, a rectangle, and a triangle are assumed in addition to the circle. If the machined hole to be formed in the workpiece 210 has a shape other than a circle, the center of the shape (for example, in a case of an ellipse, the position in the middle between two centers), the barycenter, the center of the inscribed circle, or the center of the circumcircle is read as the center of the circle in this embodiment. Accordingly, by reading the radial direction in this embodiment as the direction connecting the center (or barycenter) of the shape and the processing position, this embodiment can support various shapes other than the circle. The example of forming the machined hole having a shape other than the circle can be applied to all the description of this embodiment.

Also in this embodiment, if the optical axis of the laser light entering the image rotator 202 fluctuates with time, a positional error and an angular error occur between the rotation center (rotation axis) of the image rotator 202 and the optical axis (barycentric line) of the laser light. If the laser light fluctuates with respect to the rotation axis of the image rotator 202 and an error occurs, in accordance with the error, in addition to a rotation component, a revolution component in synchronization with the rotation cycle of the image rotator 202 is generated in the laser light emitted from the image rotator 202. As a result, a revolution component is also generated in the laser light condensed on the workpiece 210 shown in FIG. 4, and an error occurs in the shape of the machined hole formed in the workpiece 210. Since the optical axis fluctuation of the laser light can occur due to displacements caused by temperature changes of the oscillator of the laser light, the optical system provided on the preceding stage of the processing head unit 200, and the optical system of the processing head unit 200, the direction and fluctuation amount of the optical axis fluctuation of the laser light change with time. Hence, it is required to continuously detect and correct the direction and fluctuation amount of the optical axis fluctuation changing with time.

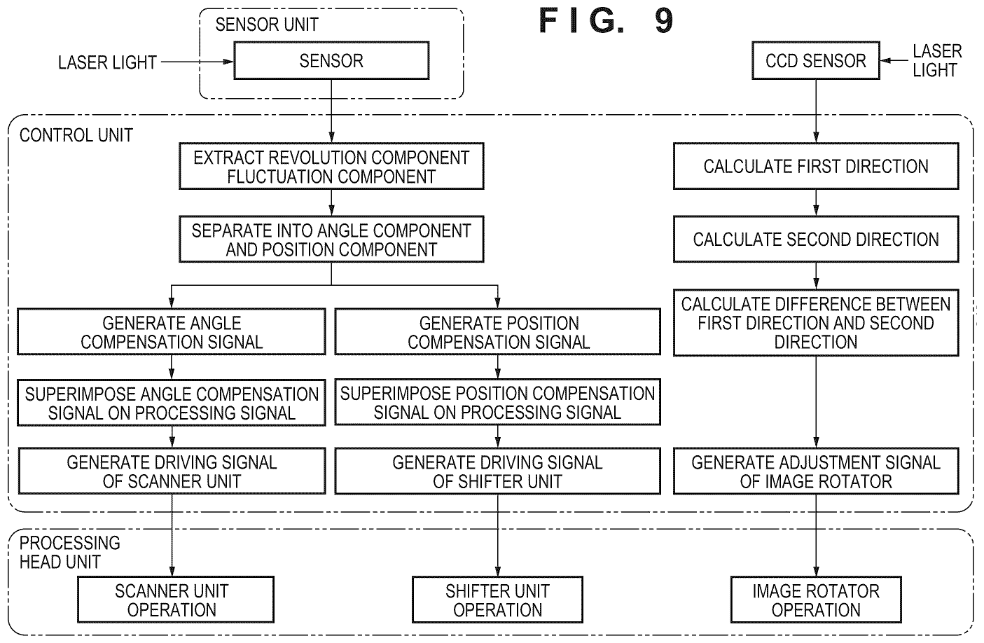

FIG. 9 is a flowchart illustrating a process procedure of the processing head unit 200, a sensor unit 220, and a control unit 230 performed to compensate the processing error caused by the revolution component generated in the image (emitted image) of the laser light 201 emitted from the image rotator 202. In this embodiment, before performing the process described with reference to FIG. 7 in the first embodiment, it is adjusted such that a portion (high intensity portion) of the laser light 201 where the intensity is higher than a predetermined intensity is located on the outer side of the machined hole. With this, better processing is implemented.

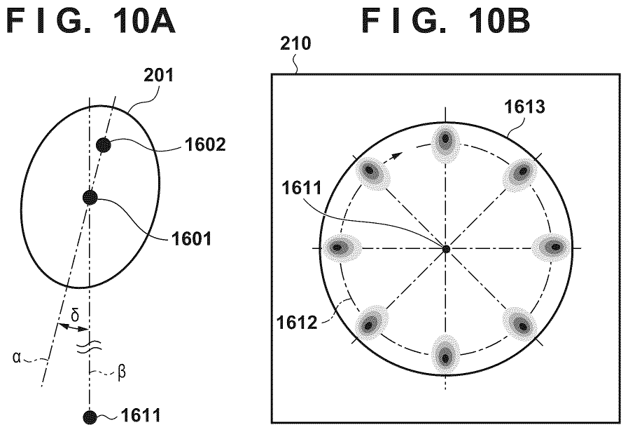

With reference to FIGS. 9 to 10B, a process concerning adjustment (control) of the image rotator 202 to make the high intensity portion of the laser light 201 located on the outer side of the machined hole will be described.

FIG. 10A shows the laser light 201 in the initial state of the image rotator 202. For example, if the high intensity portion of the laser light 201 is not located at the center position, as shown in FIG. 10A, a center position 1601 of the laser light 201 and a barycenter position 1602 of the light amount are at different positions in the laser light 201. In such a case, first, the laser light 201 emitted from the image rotator 202 is detected by a sensor such as a CCD sensor which can detect the intensity distribution, and a detection signal (the intensity distribution of the laser light 201) is transmitted to the control unit 230.

Then, from the detection signal transmitted from the sensor unit 220, the control unit 230 calculates a first direction a from the center position 1601 of the laser light 201 to the barycenter position 1602 of the light amount of the laser light 201. The control unit 230 also calculates a second direction β from the center position 1601 of the laser light 201 at the irradiation start position (processing start position) of irradiation of the workpiece 210 with the laser light 201 to a center 1611 of a trajectory 1612 (circle defined thereby) as shown in FIG. 10B. Further, the control unit 230 calculates a difference (angle difference value) δ between the first direction a and the second direction β. Then, the control unit 230 generates an adjustment signal for decreasing the difference δ to zero, that is, adjusting (setting) the initial angle of the image rotator 202 required to make the first direction a and the second direction β coincide with each other.

The adjustment signal generated by the control unit 230 is given to the image rotator 202. With this, in the processing head unit 200, the image rotator 202 is operated (rotated), and adjusted such that the high intensity portion of the laser light 201 is located on the outer side of a machined hole 1613 as shown in FIG. 10A. In addition, the laser light beams 201 entering at respective positions of the trajectory 1612 (on the trajectory) have the same shape with respect to the center 1611 of the circle defined by the trajectory 1612.

In this manner, according to the processing apparatus 1 of this embodiment, as in the first embodiment, even if the optical axis of the laser light 201 fluctuates, it is possible to perform processing with reduced influence of the fluctuation. Thus, it is possible to process the workpiece 210 with high accuracy. Further, in the processing apparatus 1 of this embodiment, before processing the workpiece 210 by irradiating the workpiece 210 with the laser light 201, the image rotator 202 is adjusted such that the high intensity portion of the laser light 201 is located on the outer side of the machined hole. With this, better processing can be implemented.

In the first embodiment and the second embodiment, the case in which the optical axis of the laser light 201 entering the image rotator 202 fluctuates with time has been taken as an example and described, but the present invention is not limited to this. For example, the present invention is also applicable to a case in which the optical axis of the laser light 201 entering the image rotator 202 is shifted from the rotation center (rotation axis) of the image rotator 202 in the assembly stage (initial stage) of the processing apparatus 1.

The processing apparatus 1 in the embodiment can be used for an article manufacturing method. The article manufacturing method includes a step of processing a workpiece (target object) using the processing apparatus 1, and a step of manufacturing an article by processing the workpiece processed in the processing step. The processing step includes at least one of, for example, processing different from the above-described processing, conveyance, inspection, sorting, assembly, and packaging. The article manufacturing method according to the embodiment is superior to a conventional method in at least one of the performance, quality, productivity, and production cost of the article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2022-072673, filed Apr. 26, 2022, which is hereby incorporated by reference herein in its entirety.

What is claimed is:

1. A processing apparatus that processes a workpiece by irradiating the workpiece with laser light, the apparatus comprising:
a rotation unit configured to rotate with a rotation axis as a center, thereby rotating an intensity distribution of the laser light emitted therefrom with the rotation axis as a center;
a scanning unit configured to scan the laser light applied to the workpiece; and
a control unit configured to irradiate the workpiece with the laser light while reducing at least one of an angular shift and a positional shift of the laser light entering the workpiece, which occur due to a shift between the rotation axis and a barycentric line of the laser light entering the rotation unit.

2. The apparatus according to claim 1, further comprising
a detection unit configured to detect a position of the barycentric line of the laser light,
wherein, based on the position detected by the detection unit, the control unit obtains at least one of the angular shift and the positional shift of the laser light entering the workpiece.

3. The apparatus according to claim 1, wherein
the shift between the rotation axis and the barycentric line of the laser light entering the rotation unit includes at least one of a positional shift and an angular shift between the rotation axis and the barycentric line.

4. The apparatus according to claim 1, wherein
the control unit irradiates the workpiece with the laser light while reducing, by the scanning unit, at least one of the angular shift and the positional shift of the laser light entering the workpiece.

5. The apparatus according to claim 4, wherein
the scanning unit includes
a first scanning unit configured to change a position of the laser light entering the workpiece, and
a second scanning unit configured to change an angle of the laser light entering the workpiece, and
the control unit irradiates the workpiece with the laser light while reducing the positional shift of the laser light entering the workpiece by the first scanning unit, and reducing the angular shift of the laser light entering the workpiece by the second scanning unit.

6. The apparatus according to claim 5, wherein
during irradiation of the workpiece with the laser light, the control unit controls the rotation unit such that the rotation unit constantly rotates the intensity distribution of the laser light.

7. The apparatus according to claim 1, wherein
the control unit
controls the scanning unit such that the laser light applied to the workpiece draws a trajectory of a circle on the workpiece, and
controls the rotation unit such that, during irradiation of the workpiece with the laser light, the laser light beams entering at respective positions on the trajectory have the same shape with respect to a center of the circle.

8. The apparatus according to claim 7, wherein
the control unit controls the rotation unit such that, during irradiation of the workpiece with the laser light, a portion of the laser light entering at each position of the trajectory, where an intensity is higher than a predetermined intensity, is located on the outer side with respect to a center of the circle.

9. The apparatus according to claim 7, wherein
before irradiating the workpiece with the laser light, the control unit adjusts the rotation unit such that a first direction from a center position of the laser light to a barycenter position of a light amount of the laser light and a second direction from the center position of the laser light at an irradiation start position of the laser light on the trajectory to a center position of the circle coincide with each other.

10. The apparatus according to claim 1, wherein
the control unit
controls the scanning unit such that the laser light applied to the workpiece draws a trajectory of a circle on the workpiece, and
controls, during irradiation of the workpiece with the laser light, the rotation unit such that the laser light beams entering at respective positions on the trajectory have the same intensity in a radial direction of the circle.

11. The apparatus according to claim 1, wherein
the scanning unit is provided on a subsequent stage of the rotation unit.

12. The apparatus according to claim 1, wherein
the rotation unit includes
an image rotation element configured to rotate an image of the laser light, and
a housing configured to accommodate the image rotation element.

13. An article manufacturing method comprising:
processing a workpiece using a processing apparatus defined in claim 1; and
manufacturing an article by processing the workpiece processed in the processing.
